(19) United States
(12) Patent Application Publication
(10) Pub. No.: US 2005/0075259 A1
(43) Pub. Date: Apr. 7, 2005

(54) Aromatic cleanser kit

(76) Inventors: Bruce P. FaBrizio, Corona del Mar, CA (US); Gregory A. Frankenfield, North Wales, PA (US); Jeffrey L. Hyder, Huntington Beach, CA (US); Dean Plemon, Irvine, CA (US); Patrick K. Sheehan, Lincolnshire, IL (US)

Correspondence Address: CHRISTIE, PARKER & HALE, LLP, PO BOX 7068, PASADENA, CA, 91109-7068, US

(21) Appl. No.: 10/678,482

(22) Filed: Oct. 3, 2003

(51) Int. Cl. C11D 17/04

(52) U.S. Cl. 510/277

(57) ABSTRACT

An aroma cleanser kit comprising a multi-component kit that allows an end-use consumer to select from a multiplicity of fragrances for addition to a common unscented cleanser, and a method of using such a kit to modify the fragrance of a cleanser are provided.

### FIELD OF THE INVENTION

The current invention is directed generally to an aromatic cleanser kit, and more particularly to a kit which allows a user to customize the color and scent associated with a multipurpose household cleanser.

### BACKGROUND OF THE INVENTION

The positive benefits of aromatherapy have long been known in the incense and other environmental aromatic arts. In most cases it is recommended that the type of aroma be matched with the mood a user is attempting to set. As a result incense, perfumes, fragrant oils, etc. usually come in a wide variety of aromas. More recently manufacturers have begun to scent other home products, such as household cleansers, to cover-up the often unpleasant aroma of the active ingredients of the cleanser such as ammonia or vinegar and provide a more pleasant environment for the user.

For example, scented or fragrant cleansers have been used in homes for many years. Typically, these cleaning products are mixed with fragrances that are considered “refreshing”, such as, pine or floral aromas. However, because the cleanser is pre-scented, the user has no ability to modify the scent of the product, such as, for example to reflect a change in seasons. Moreover, many of the current home cleaning products are toxic. Such products would clearly be unsuitable for any operation that would require the consumer to add scent or color to the product at home because of the risk that the consumer would inadvertently come into contact with the toxic product.

Accordingly, a need exists for a preferably non-toxic cleanser product and associated fragrance kit that would allow for the modification of the aroma of the cleanser by the user.

### SUMMARY OF THE INVENTION

The present invention is directed to an aroma cleanser kit, and more specifically to a multi-component kit that allows an end-use consumer to select from a multiplicity of fragrances for addition to a common unscented cleanser.

In one embodiment, the cleanser/aroma kit of the current invention would contain a concentrated cleanser product, a prelabeled dispenser providing instructions on diluting the concentrated cleanser for use, and a selection of dissolvable fragrance materials.

In another embodiment, the fragrance materials effervescent dissolvable tablets, which when added to the cleanser homogeneously disperse throughout the diluted cleanser.

In yet another embodiment, the fragrance materials are concentrated scent solutions, powders or crystals.

In still another embodiment, the fragrance materials have a different color associated with each of the unique aromas to provide a visual indicator of the aroma to be dispensed.

In still yet another embodiment, either or both of the fragrance material and the concentrated cleanser are non-toxic.

In still yet another embodiment, the invention is directed to a method of imbuing a cleanser with a fragrance using the cleanser/fragrance kit of the current invention.

### BRIEF DESCRIPTION OF THE DRAWINGS

These and other features and advantages of the invention will be apparent from the following detailed description, appended claims, and accompanying drawings, in which:

FIG. 1 is a somewhat diagrammatic representation of the components of an exemplary cleanser/aroma kit in accordance with one embodiment of the current invention.

FIGS. 2a to 2e show somewhat diagrammatic representations of the steps of an exemplary method of adding fragrance to a cleanser using the cleanser/aroma kit in accordance with one embodiment of the current invention.

FIG. 3 is a flowchart of the steps of an exemplary method of adding fragrance to a cleanser using the cleanser/aroma kit in accordance with one embodiment of the current invention.

### DETAILED DESCRIPTION OF THE INVENTION

The present invention is directed to an aromatic or aroma cleanser kit (the kit), and more specifically to a multi-component aromatic cleanser kit that allows an end-use consumer to select from a multiplicity of fragrances for addition to a common unscented cleanser.

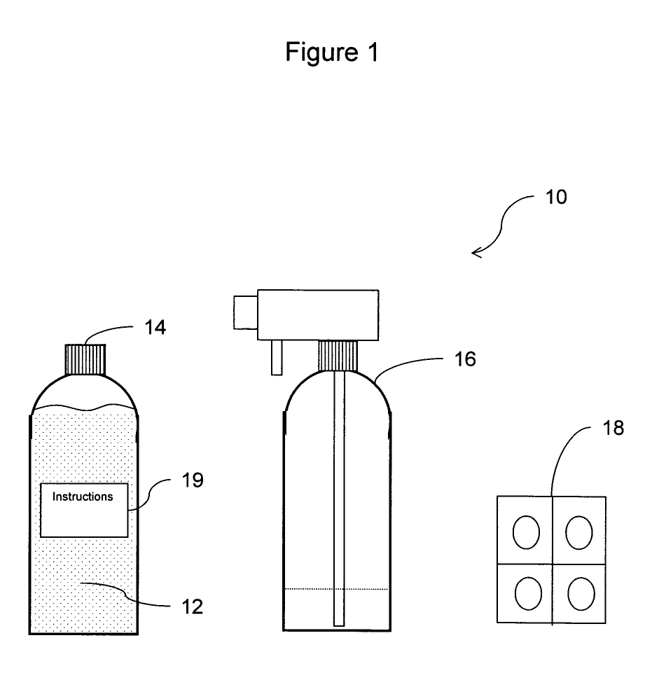

FIG. 1 shows a schematic diagram of the various components of one exemplary kit 10. As shown, in one embodiment the kit contains a quantity of concentrated cleanser product 12 in a storage container 14, a separate dispenser bottle 16 for diluting the concentrated cleanser product 12, and a selection of dissolvable fragrance materials 18.

As further shown in FIG. 1, the kit may also include instructions 19 on diluting the concentrated cleanser and introducing the fragrance material to the diluted product. Although these instructions are preprinted on the dispenser bottle in the embodiment shown in FIG. 1, it should be understood that instructions could be provided on a separate page, on the dispenser bottle, in multiple places on the components, or in any other form suitable for communicating the directions to a user.

Moreover, although the cleanser is a concentrate in the embodiment shown in FIG. 1, it should be understood that the cleanser could be provided in a pre-diluted ready to use form. In such an embodiment, either a single dispenser bottle could be provided, or a separate bottle with diluted cleanser could be provided to refill the dispenser when empty.

It should be further understood that the specific number of bottles and the form of the dispenser are not critical to the invention as long as a quantity of cleanser and a selection of fragrance tablets capable of dissolving and dispersing in the cleanser are provided. Indeed, any number of bottles or types of dispensers may be included in a kit in accordance with the present invention. Suitable dispensers might include, for example, trigger-type spray bottles, squeeze-type squirt bottles, aerosol cans, etc.

Any suitable type of cleanser may be included in the kit of the current invention such that the cleanser in a diluted, or ready-to-use form is capable of dissolving and dispersing the fragrance material, such as, for example, household cleansers, glass cleansers, automotive cleanser, carpet cleansers, disinfectants, dish detergents, clothes detergents, wood cleansers, floor cleansers, etc. In one preferred embodiment, the cleanser is a non-toxic multi-purpose household cleanser.

Likewise, any fragrance material capable of dissolving and dispersing in the selected cleanser may be included in the kit of the current invention. In one preferred embodiment, the fragrance material is an effervescent tablet comprising a bicarbonate material molded together with a suitable fragrance. In such an embodiment the tablet effervesces when placed into contact with a liquid. The bubbles generated thereby serve to release and mix the fragrance with the cleanser thereby dissolving and dispersing the fragrance without the need for any agitating action by the user.

Although one embodiment of the fragrance material is described above, it should be understood that fragrance material may come in any form which allows for the delivery of an appropriate concentration of the fragrance to the cleanser product. For example, the fragrance material may come as liquid solutions, dissolvable capsules, crystals, powders, gels, etc. Likewise, any number and type of suitable aromas may be used with the kit of the present invention. In one preferred embodiment the fragrance materials included in the kit are non-toxic.

In one embodiment, the fragrance material further contains an associated color such that each provided aroma can be identified visually. Alternatively, the color may be provided separately in any of the above mentioned forms for addition to the cleanser and fragrance. Regardless of the form, such a color additive should be generally non-staining and preferably non-toxic.

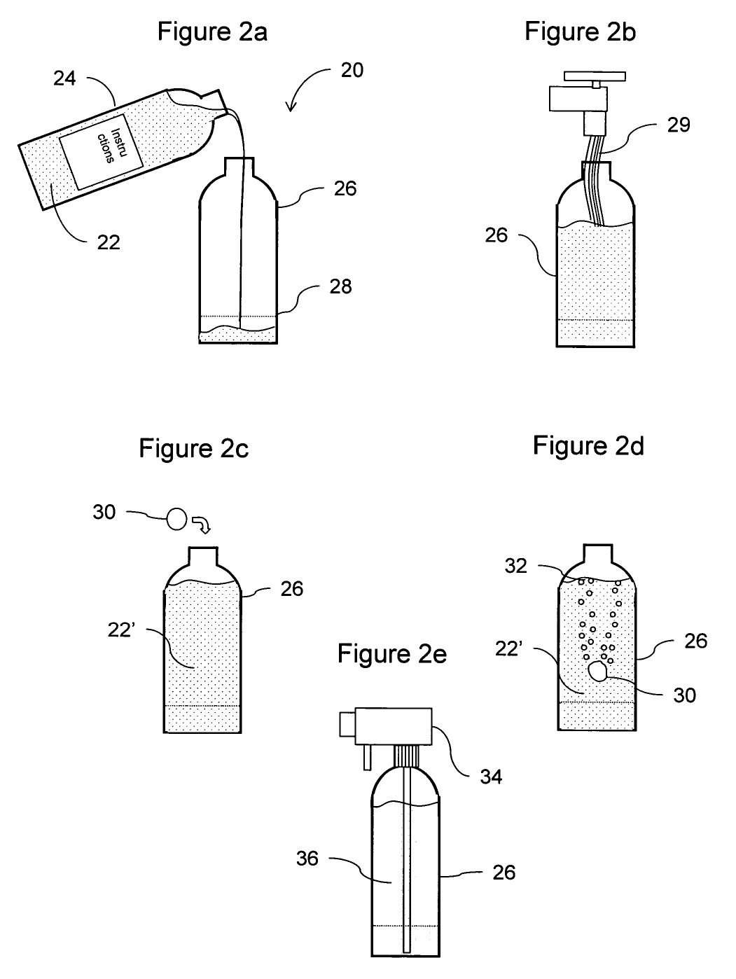

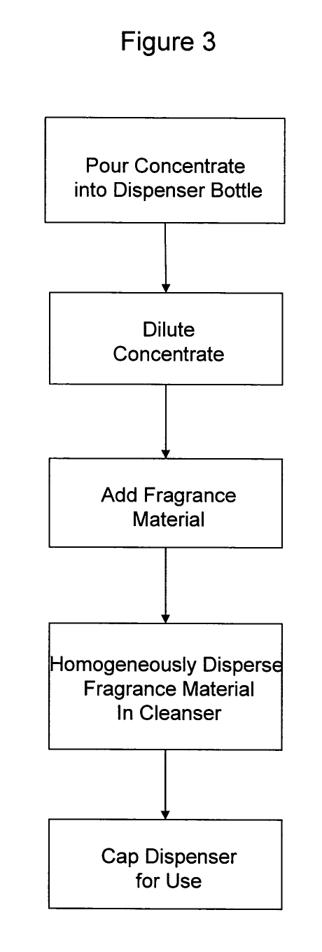

FIGS. 2a to 2e and 3 provide pictorial and flowchart diagrams of the operation of the kit 20 in accordance with the present invention.

As shown in FIG. 2a, first the concentrate cleanser 22 is transferred from the concentrate container 24 to the dispenser container 26. To ensure an appropriate concentration of the cleanser is provided, the dispenser bottle may have a fill line 28 marked on the side of the bottle. In FIG. 2b, the concentrate cleanser 22 in the dispenser container 26 is then diluted with an appropriate dilutant 29, such as, for example, water. Alternatively, if the cleanser is in a ready-to-use state, the dilution step can be skipped and the cleanser directly added to fill the dispenser container 26.

Once the diluted cleanser 22′ is prepared, the fragrance material 30 is added to the dispenser bottle 26. As shown in FIG. 2c, where the fragrance material is in the form of an effervescent tablet 30 this step entails dropping the tablet into the dispenser bottle 26. In a case where the fragrance material is in the form of an effervescent tablet, the fragrance material 30 must be given time to effervesce 32 and mix with the cleanser to form the aromatic cleanser prior to sealing the bottle, as shown in FIG. 2d. This waiting period is necessary to ensure that the effervescing fragrance material has sufficiently dispersed into the cleanser. It should be understood that this step is not necessary when using fragrance materials without this effervescent quality, such as, for example, liquid fragrances, crystals, powders, etc.

Finally, as shown in FIG. 2e, once the gas has been released from the tablet the dispenser bottle 26 can be capped 34 and the aromatic cleanser 36 used. Optionally, the capped bottle may be agitated to ensure thorough dispersion of the fragrance within the cleanser. In a preferred embodiment, the fragrance material may further contain a dye colorant that provides a visual measure of the degree of mixing between the fragrance material and cleanser.

Although specific embodiments are disclosed herein, it is expected that persons skilled in the art can and will design alternative aromatic cleanser kits and methods of using such kits that are within the scope of the following description either literally or under the Doctrine of Equivalents.

1. An aromatic cleanser kit comprising:
a quantity of unscented cleanser;
a dispenser bottle for containing and dispensing the unscented cleanser; and
a plurality of fragrance materials having at least two different aromas.

2. The aromatic cleanser kit as described in claim 1, wherein the unscented cleanser is in a highly concentrated form, and wherein the kit further comprises a concentrate container for storing the concentrated cleanser.

3. The aromatic cleanser kit as described in claim 2, wherein the dispenser bottle is further marked with a fill line identifying a quantity of concentrated unscented cleanser to add to the dispenser bottle.

4. The aromatic cleanser kit as described in claim 1, wherein the unscented cleanser is dilute.

5. The aromatic cleanser kit as described in claim 1, wherein the plurality of fragrance materials are provided as a plurality of effervescent tablets of fragrance material.

6. The aromatic cleanser kit as described in claim 1, wherein the plurality of fragrance materials are scented materials selected from the group consisting of oils, powders, crystals, and solutions.

7. The aromatic cleanser kit as described in claim 1, wherein the plurality of fragrance materials further comprise at least one colorant.

8. The aromatic cleanser kit as described in claim 7, wherein each of the fragrance materials having the different aromas have a different colorant.

9. The aromatic cleanser kit as described in claim 1, wherein the cleanser is non-toxic.

10. The aromatic cleanser kit as described in claim 1, wherein the fragrance material is non-toxic.

11. An aromatic cleanser kit comprising:
a quantity of non-toxic highly concentrated unscented cleanser;
a concentrate container for storing the concentrated unscented cleanser;
a dispenser bottle for containing and dispensing a diluted unscented cleanser; and
a plurality of effervescent tablets having a combination of an effervescent material, a fragrance material, and a colorant, wherein the fragrance materials of at least two of the effervescent tablets have different aromas and colorants.

12. A method of scenting a cleanser comprising:
providing an aromatic cleanser kit comprising a highly concentrated unscented cleanser, a dispenser bottle, and a plurality of fragrance materials having at least two different aromas;
adding a quantity of the highly concentrated unscented cleanser to the dispenser bottle;
diluting the concentrated unscented cleanser in the dispenser bottle;
adding one of the plurality of fragrance materials to the diluted unscented cleanser; and
homogeneously dispersing the fragrance material throughout the diluted cleanser.

13. The method as described in claim 12, wherein the plurality of fragrance materials are provided as effervescent tablets of fragrance material, and wherein the effervescence of the effervescent tablet automatically homogenously disperses the fragrance material throughout the cleanser.

14. The method as described in claim 12, wherein the plurality of fragrance materials are scented materials selected from the group consisting of oils, powders, crystals, and solutions.

15. The method as described in claim 14, wherein homogeneously dispersing comprises agitating the fragrance material and the diluted unscented cleanser.

16. The method as described in claim 12, wherein the plurality of fragrance materials further comprise at least one colorant.

17. The method as described in claim 16, wherein each of the fragrance materials having the different aromas have a different colorant.

18. The method as described in claim 12, wherein the cleanser is non-toxic.

19. The method as described in claim 12, wherein the fragrance material is non-toxic.
